(19) United States
(12) Patent Application Publication
(10) Pub. No.: US 2016/0171606 A1
(43) Pub. Date: Jun. 16, 2016

(54) PORTFOLIO CONSTRUCTION

(71) Applicants: Kandarp R. Acharya, Walnut Creek, CA (US); Jonathan W. Reining, Piedmont, CA (US); Christian Chan, Orinda, CA (US)

(72) Inventors: Kandarp R. Acharya, Walnut Creek, CA (US); Jonathan W. Reining, Piedmont, CA (US); Christian Chan, Orinda, CA (US)

(73) Assignee: Wells Fargo Bank, N.A., Charlotte, NC (US)

(21) Appl. No.: 14/565,632

(22) Filed: Dec. 10, 2014

(51) Int. Cl. G06Q 40/06

(52) U.S. Cl. CPC G06Q 40/06

(57) ABSTRACT

Systems, methods, and other embodiments associated with portfolio construction. According to one embodiment, a method includes converting qualitative data into quantitative data. The qualitative data is associated with sleeves in a set of sleeves. Investment risks and risk capitals for the sleeves are aggregated. The sleeves are assessed based on investment factors including the quantitative data, the investment risks, and the risk capitals. The method also includes creating portfolios based, at least in part, on the investment factors. A portfolio contains at least one sleeve. The portfolios are assigned risk weights based on the one or more investment factors. The risk weights of the portfolios are compared to a risk target. A portfolio is then selected based on the comparison.

### BACKGROUND

Regulatory schemes, such as the Dodd-Frank and Basel-III rules, have been instituted to ensure the safety and soundness of financial institutions (e.g., banks, credit unions, building societies, trust companies, insurance companies, pension funds, underwriters, brokerage firms, mortgage loan companies, etc.). Specifically, the regulatory schemes are instituted to mitigate the risk to taxpayers and deposit-holders in the event that a financial institution becomes insolvent. For example, a financial institution must be well capitalized so that the financial institution does not take on excess leverage because under certain circumstance that excess leverage may make the financial institution insolvent. Whether a financial institution is well capitalized is expressed by a financial institution's risk-based capital ratio. A financial institution's risk based capital ratio is obtained by dividing its capital base by its risk-weighted assets. For a financial institution to be considered well capitalized under the code, the risk based capital ratio must be sufficiently low.

Financial institutions manage portfolios containing financial assets. After a financial institution receives, the financial institution periodically assess the portfolios to determine the balance of the return and risk of individual portfolios. Using the return and risk information from the performing portfolio, a risk weight for the portfolio is calculated to track the performance of the portfolio. Accordingly, financial institution assess risk retroactively on portfolios that are already performing.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

As discussed above, financial institutions assess risk retroactively once a portfolio is already performing. Described herein are examples of systems, methods, and other embodiments associated with portfolio construction. Specifically the portfolios may be created to manage assets related to Bank Owned Life Insurance (BOLI). In one embodiment, the process uses qualitative data. In one example, the qualitative data are estimates of the performance of a specific sleeve. The sleeve represents a specialty income class related to a group of products (e.g. municipal bonds, mortgage backed securitized bonds, treasury backed bonds, corporate backed bonds, etc.) in a financial sector.

The qualitative data are converted into quantitative data. In one embodiment, the qualitative data are converted using a z-score methodology. The converted quantitative data can then be used as an alpha estimate. The investment risk associated with each sleeve can then be assessed using a vended multi-asset, multi-factor, global risk model. As discussed above, the Dodd-Frank and Basel-III rules specify the risk capital that financial institutions need to set aside due to holding risky fixed income securities. Accordingly, the investment risk of various sleeves can be calculated and used to create portfolios that will then have a risk weight corresponding to the investment risk of the sleeves included in the portfolio. Accordingly, portfolios can be created to maintain the risk capital the financial institution is required to set aside while maximizing the total return as adjusted for risk.

As the qualitative data change, the process considers those changes. For example, the risk weight of a portfolio can be adjusted based on the changes while continuing to maximize the risk adjusted return. Furthermore, the process can be adapted to target measurable fixed income characteristics such as duration or current yield. Thus, the embodiments described herein create portfolios by assessing both the risk capital and the risk weight of potential portfolios before selecting a portfolio. The embodiments may also continue to account for both the risk capital and the risk weight throughout the life of the portfolio.

The following description and drawings set forth certain illustrative aspects and implementations. These are indicative of but a few of the various ways in which one or more aspects may be employed. Other aspects, advantages, or novel features of the disclosure will become apparent from the following detailed description when considered in conjunction with the drawings.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of a system associated with portfolio construction.

FIG. 2 illustrates one embodiment of a system associated with portfolio construction.

FIG. 3 illustrates another embodiment of a method associated with portfolio construction.

FIG. 4 illustrates one embodiment of a method associated with portfolio construction.

FIG. 5 illustrates one embodiment of an example computer environment associated with portfolio construction.

### DETAILED DESCRIPTION

Embodiments or examples illustrated in the drawings are disclosed below using specific language. It will nevertheless be understood that the embodiments or examples are not intended to be limiting. Any alterations and modifications in the disclosed embodiments and any further applications of the principles disclosed in this document are contemplated as would normally occur to one of ordinary skill in the pertinent art. Described herein are examples of systems, methods, and other embodiments associated with portfolio construction.

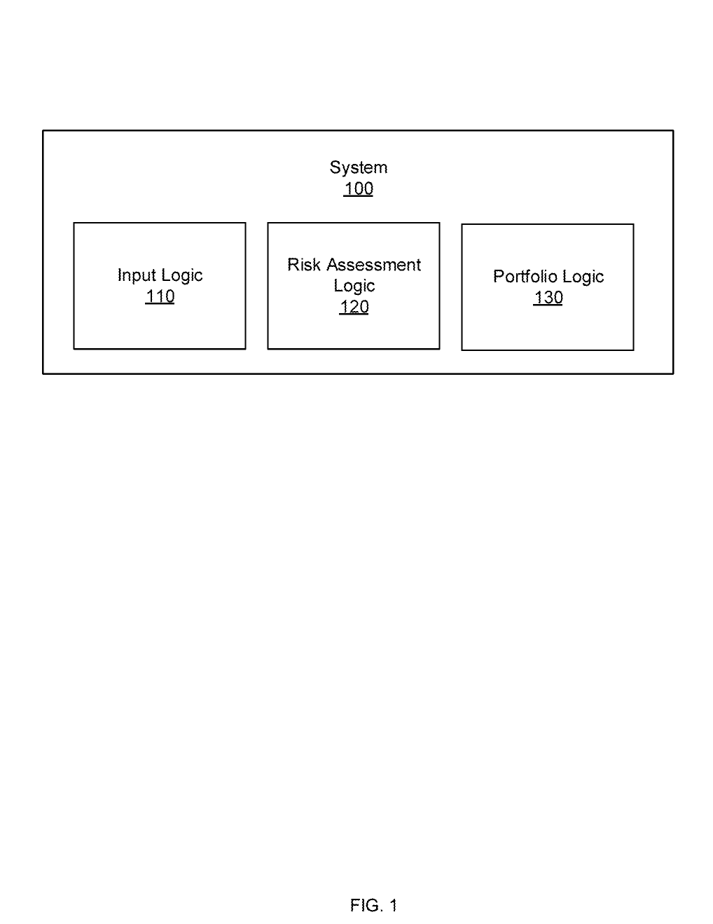

FIG. 1 is an illustration of an example system 100 associated with portfolio construction. The system 100 may be implemented by financial institutions to construct portfolios. For example, the system 100 may be used in conjunction with a computer readable medium. In another embodiment, the system 100 may be used in conjunction with a database holding information about a number of different sleeves. The system 100 includes an input logic 110, a risk assessment logic 120, and a portfolio logic 130.

The input logic 110 is configured to receive qualitative data regarding a sleeve. As discussed above, a sleeve represents a specialty income class (e.g., municipal bonds, mortgage backed securitized bonds, treasury backed bonds, corporate backed bonds, etc.). The qualitative data may be an estimate of total return, including the curve and movement, of a given sleeve. For example, assume a manager at a financial institution estimates the total return of a specific sleeve. The total return may be based on different income factors such as coupon income, price return, and the exposure to risk of the sleeve. The input logic 110 receives the estimate as qualitative data. The input logic 110 then converts the received qualitative data to quantitative data. In one embodiment, the qualitative data is used to calculate an alpha score. The resulting alpha score may represent the quantitative data. Thus, the alpha score represents the estimated income of a sleeve.

The risk assessment logic 120 aggregates investment factors, such as the quantitative data, an investment risk, and a risk capital for a plurality of sleeves. The investment factors may be received by the risk assessment logic 120 from external components. Alternatively, the risk assessment logic 120 may calculate the investment factors, as will be discussed below.

In one embodiment, the risk assessment logic 120 receives the quantitative data. The risk assessment logic 120 may also receive the investment risk of each sleeve. In another embodiment, the risk assessment logic 120 may calculate the investment risk using a vended multi-asset, multi-factor, global risk model, hereinafter referred to as a vended risk model. The vended risk model introduces the investment risk, but the vended risk model does not need to classify products as bonds or structured notes. Instead, the vended risk model is a uniform framework for assessing risk. Although the investment risk may be calculated using a vended risk model, other models may be used.

As with the investment risk, the risk assessment logic 120 may also receive the risk capital. Alternatively, the risk assessment logic 120 may calculate the risk capital based on a regulatory scheme. As discussed above, the risk capital may defined for sleeves by the regulatory scheme. For example, when a financial institution invests balance sheet assets, a certain amount of capital should be reserved. The amount of capital to be reserved is termed the risk capital. In some embodiments, the risk capital may be defined by a straightforward formula. However, for some sleeves the formula for calculating the capital requirement may be complex and include a number of assumptions. By aggregating this information, the risk assessment logic 120 determines a number of investment factors for each sleeve in a plurality of sleeves.

The portfolio logic 130 creates portfolios. Specifically, the portfolio logic 130 creates a portfolio by combining a number of sleeves. For example, a portfolio may include various sleeves of a fixed income market. The portfolio logic 130 selects sleeves to combine based on the investment factors of the sleeves. For example, the investment factors may include the (i) the quantitative data, (ii) the investment risk, and (iii) the risk capital determined by the risk assessment logic 120. The investment factors may be combined linearly. Alternatively, the investment factors may be combined to achieve a particular investment outcome. For example, the portfolio logic 130 combines the sleeves such that the risk capital may be held constant and the quantitative data (i.e., estimate of the income of the sleeve) may be balanced with the investment risk. In this manner, the three factors can be tailored to create portfolios with a desired tradeoff between income and risk while maintaining the required risk capital.

Once a portfolio is created by combining sleeves, the portfolio has a number of characteristics that correspond to the investment factors of the combined sleeves. For example, a risk weight of a portfolio corresponds investment risk determined for the sleeves contained in the portfolio. Thus, the risk weight represents the risk associated with the portfolio based on the risk associated with the sleeves. Likewise, the capital weight of the portfolio corresponds to risk capital associated with each of the sleeves. Thus, the risk weight and capital weight represent the portfolio as a whole.

The portfolios created by the portfolio logic 130 may have similar risk weights but different risk and return characteristics. The portfolio logic 130 compares the risk weight of a portfolio to a risk target. The risk target may be set based on the client's risk tolerance and their goals. A portfolio is selected from the set of portfolios based, at least in part, on the comparison. Accordingly, a portfolio is selected to optimize the risk-return outcome of the portfolio's performance. In this manner, portfolios can be created to have specific characteristics. For example, portfolios can be created that have a constant risk weight but varying capital weights and income estimates.

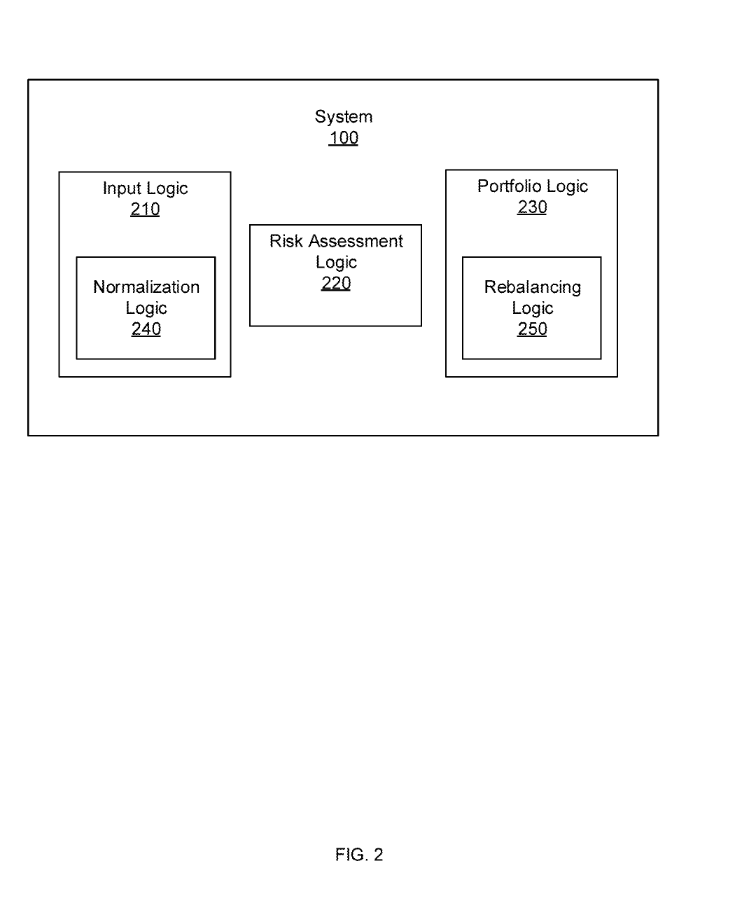

FIG. 2 illustrates one embodiment of a system 200 associated with portfolio construction. The system 200 includes an input logic 210, a risk assessment logic 220, and a portfolio logic 230. The input logic 210, the risk assessment logic 220, and the portfolio logic 230 operate in a similar manner as the input logic 110, the risk assessment logic 120, and the portfolio logic 130 respectively, described with respect to FIG. 1. The input logic 210 includes a normalization logic 240. The portfolio logic 230 includes a rebalancing logic 250.

The normalization logic 240 normalizes the received qualitative data. Specifically, the qualitative data for a sleeve is normalized in comparison with the qualitative data of the other sleeves. For example, consider that a first set of qualitative data may represent a single sleeve and a second set of qualitative data may represent the qualitative data of the remaining sleeves. To normalize the qualitative data, the second set of qualitative data may be averaged. An intermediate result is calculated by subtracting the first set of qualitative data from the averaged second set of qualitative data. The intermediate result is then divided by the standard deviation of the first and second set of qualitative data to generate an end result. The end result is a z-score. By normalizing the qualitative data of a sleeve, the likelihood that a single source of data will skew future calculations is reduced.

The rebalancing logic 250 monitors the performance of the selected portfolio so that changes can be made. The rebalancing logic 250 identifies anomalous characteristics of the portfolio. For example, suppose that a sleeve of the portfolio is not meeting its estimated income. The rebalancing logic 250 identifies the underperforming sleeve. In one embodiment, the rebalancing logic 250 can then replace the sleeve causing the anomalous activity with a sleeve performing as expected. In one embodiment, the rebalancing logic 250 may identify a replacement sleeve based on the investment factors of the sleeve. Thus, in addition to creating portfolios with specific characteristics, the portfolios can be rebalanced to replace anomalous sleeves. In another embodiment, the rebalancing logic 250 may alter the sleeve causing the anomalous activity such that the sleeve conforms to an expected performance. Accordingly, the rebalancing logic 250 may replace or alter anomalous sleeves.

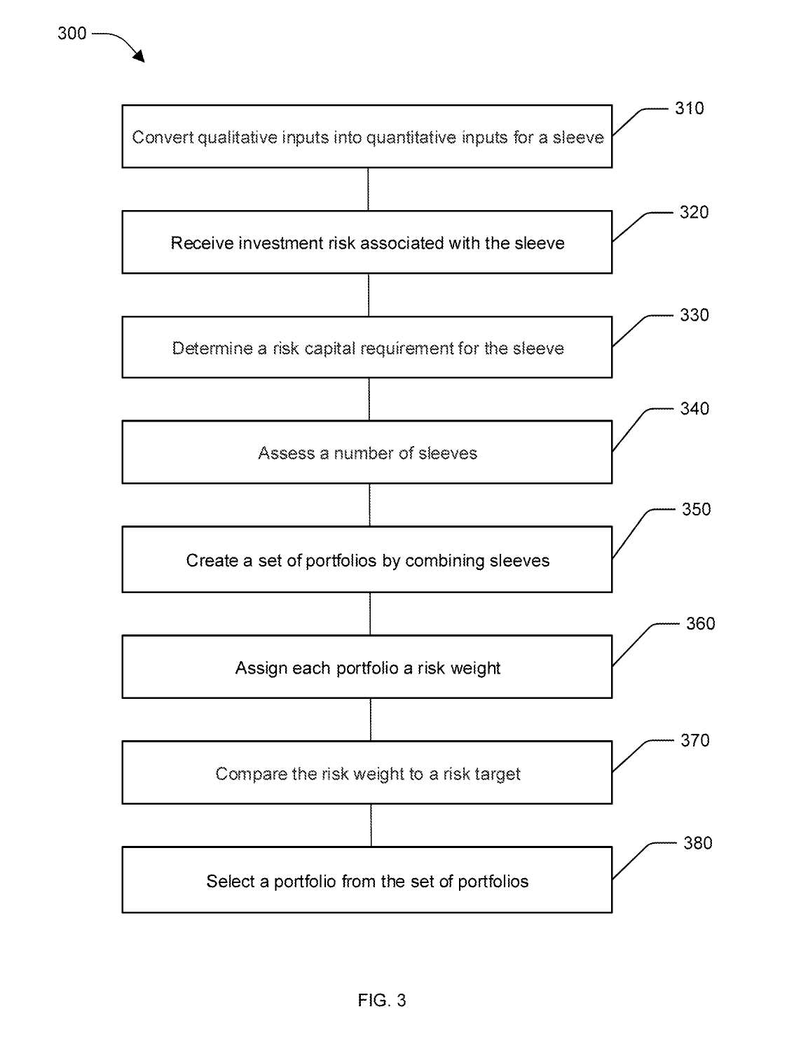

FIG. 3 illustrates one embodiment of a method associated with portfolio construction. At 310, qualitative data associated with a sleeve are converted into quantitative data. The qualitative data represent the estimated income of a sleeve. The qualitative data may be converted using a normalization process. Accordingly, the conversion of qualitative data to quantitative data may be used to adjust the qualitative data since the qualitative data may be based on different scales. Accordingly, conversion aligns the qualitative data resulting in quantitative data.

At 320, an investment risk associated with the sleeve is identified by either being received or calculated. As discussed above, the investment risk of a sleeve may be based on a vended risk model. The investment risk identifies the likelihood that the sleeve will suffer a loss. At 330, an amount of risk capital is determined. The amount of the risk capital is set by a regulatory scheme. Accordingly, the risk capital may be obtained from a regulatory body. Thus, both the investment risk and the risk capital may be received from external components.

At 340, a number of sleeves are assessed based on the quantitative data, investment risk, and risk capital. Once the sleeves have been assessed, a set of portfolios are created, at 350. A portfolio includes a number of sleeves. As discussed above, the different portfolios in the set of portfolios may have different income and risk estimates but a constant capital requirement.

At 360, each of the portfolios in the set of portfolios is assigned a risk weight. The risk weight is based on the risk assessment of each of the sleeves in the created portfolio. The risk weight of the portfolio may be further based on the quantitative data associated with at least some of the sleeves included in the portfolio. At 370, the risk weight of the portfolios is compared to a target risk. The target risk is set based on a desired balance between the estimated income and risk associated with a portfolio. At 380, a portfolio is selected from the set of portfolio based on the comparison. In one embodiment, a portfolio is selected based on the portfolio that most accurately reflects the target risk.

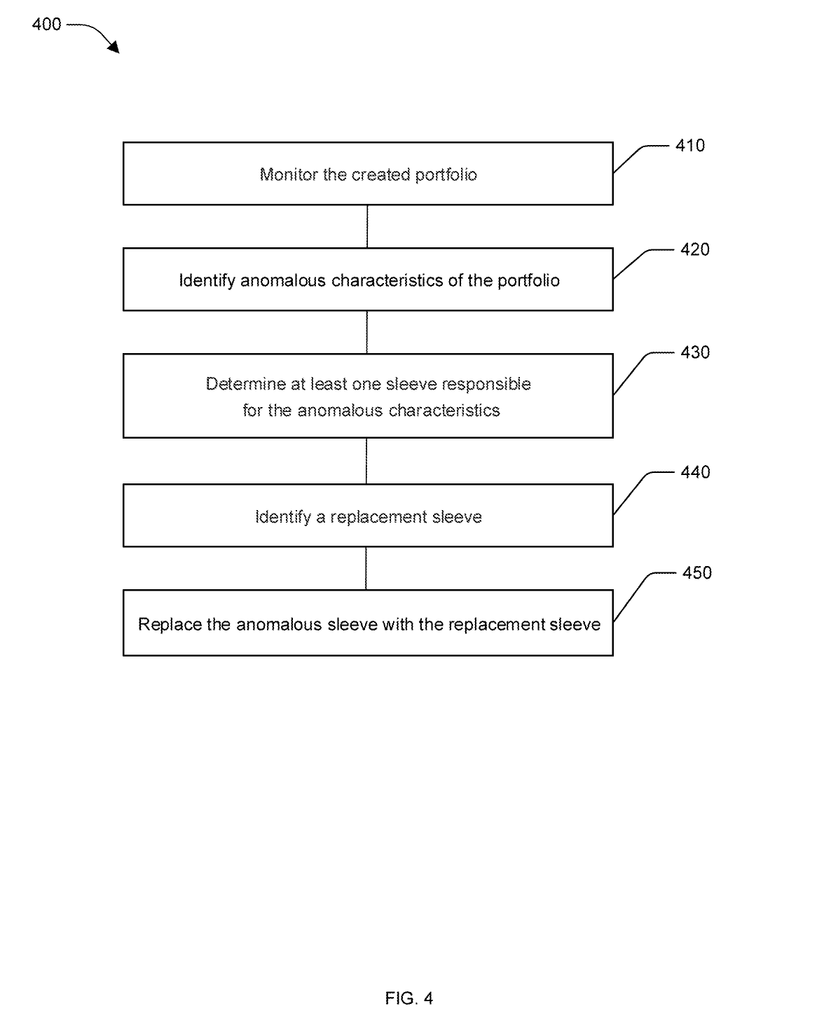

FIG. 4 illustrates one embodiment of a method associated with portfolio construction for rebalancing a portfolio. Suppose that a portfolio is created; for example, using the method described with respect to FIG. 3. Once the portfolio has been created, the portfolio is monitored at 410. For example, the performance (e.g. return, risk exposure, etc.) may be monitored.

At 420, anomalous characteristics of the portfolio are identified. In one example, the anomalous characteristics are identified by comparing the characteristics of the portfolio to an expectation for the portfolio. The expectation may be determined by the investment factors of the individual sleeves included in the portfolio. At 430, at least one sleeve is determined to be responsible for anomalous characteristics of the portfolio. The responsible sleeve is referred to as the anomalous sleeve. For example, while determining which sleeves contain investment factors not performing in the manner expected.

At 440, a replacement sleeve is identified. A replacement sleeve is identified from previously analyzed sleeves based on the investment factors and the current performance of the sleeve. At 450, the identified replacement sleeve replaces the sleeve responsible for the anomalous characteristics. Thus, in addition to creating portfolios with specific characteristics, the portfolios can be rebalanced to replace anomalous sleeves. Accordingly, portfolios can be rebalanced to have the sleeves analyzed at the portfolio's creation.

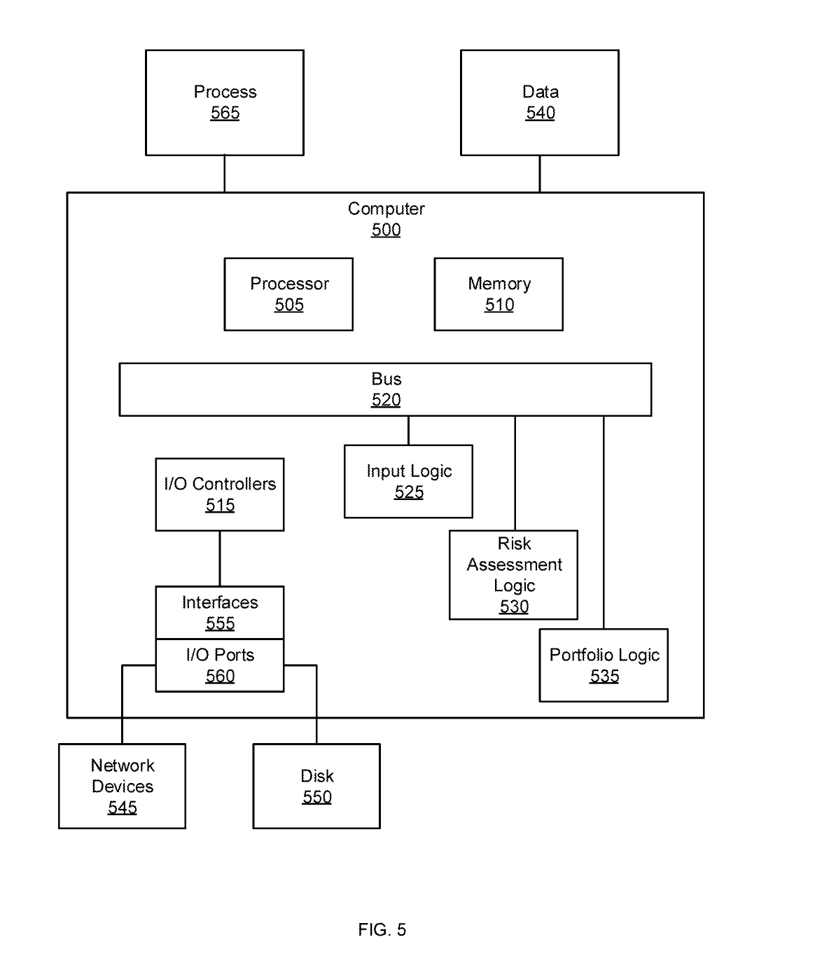

FIG. 5 illustrates one embodiment of an example computer environment associated with automated secondary linking of fraud detection systems. The computer environment in which the systems and methods described herein, and equivalents, may operate may include a computer 500. The computer includes a processor 505, a memory 510, and input/output (I/O) ports 515 operably connected by a bus 520. In one example, the computer 500 may include an input logic 525, a risk assessment logic 530, and a portfolio logic 535.

The input logic 525 is configured to receive qualitative data representing estimates for the performance of a particular sleeve. The input logic 525 converts the qualitative data to quantitative data. As a part of the conversion of qualitative data to quantitative data, the input logic 525 may normalize the qualitative data. The risk assessment logic 530 aggregates investment factors of the sleeves. For example, the risk assessment logic 530 may receive and/or calculate investment factors. For example, the risk assessment logic 530 may receive quantitative data from the input logic 525. The risk assessment 530 may calculate the investment risk or the capital risk. The portfolio logic 535 creates a set of portfolios by combining different sleeves based on the investment factors. The portfolio logic 535 also assigns each created portfolio a risk weight based on the combination of the risk of each sleeve contained in the portfolio. The portfolio logic 535 select a specific portfolio from the set of portfolios based, at least in part, on comparing the risk weight of the portfolio with a risk target

In different examples, the input logic 525, the risk assessment logic 530, and the portfolio logic 535 may be implemented in hardware, a non-transitory computer-readable medium with stored instructions, firmware, and/or combinations thereof. While the input logic 525, the risk assessment logic 530, and the portfolio logic 535 are illustrated as hardware components attached to the bus 520, it is to be appreciated that in one example, the input logic 525, the risk assessment logic 530, and the portfolio logic 535 could be implemented in the processor 505.

In one embodiment, the input logic 525 is a means (e.g., hardware, non-transitory computer-readable medium, firmware) for receiving qualitative input and converting the qualitative input into a quantitative input. The risk assessment logic 530 is a means (e.g., hardware, non-transitory computer-readable medium, firmware) for calculating the risk of a sleeve. The portfolio logic 535 is a means (e.g., hardware, non-transitory computer-readable medium, firmware) for creating portfolios and determining the risk weight of each of the portfolios. The portfolio logic 535 may then select or receive a selection for at least one portfolio. The means may be implemented, for example, as an application specific integrated circuit (ASIC) programmed to facilitate data editing in a web-based interactive web response system. The means may also be implemented as stored computer executable instructions that are presented to computer 500 as data 540 that are temporarily stored in memory 510 and then executed by processor 505.

Generally describing an example configuration of the computer 500, the processor 505 may be a variety of various processors including dual microprocessor and other multi-processor architectures. The memory 510 may include volatile memory and/or non-volatile memory. Non-volatile memory may include, for example, ROM, PROM, and so on. Volatile memory may include, for example, RAM, SRAM, DRAM, and so on.

Network device 545 and a disk 550 may be operably connected to the computer 500 via, for example, an I/O interfaces (e.g., card, device) 555 and an I/O ports 560. The disk 545 may be, for example, a magnetic disk drive, a solid state disk drive, a floppy disk drive, a tape drive, a Zip drive, a flash memory card, a memory stick, and so on. Furthermore, the disk 545 may be a CD-ROM drive, a CD-R drive, a CD-RW drive, a DVD ROM, and so on. The memory 510 can store data 540 and/or a process 565, for example. The disk 550 and/or the memory 510 can store an operating system that controls and allocates resources of the computer 500.

The bus 520 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 520 can be types including, for example, a memory bus, a memory controller, a peripheral bus, an external bus, a crossbar switch, and/or a local bus.

The computer 500 may interact with I/O devices via the I/O interfaces 555 and the I/O ports 560. Input/output devices may be, for example, a keyboard, a microphone, a pointing and selection device, cameras, video cards, displays, the network devices 545, the disk 550, and so on. The I/O ports 560 may include, for example, serial ports, parallel ports, and USB ports.

The computer 500 can operate in a network environment and thus may be connected to the network devices 545 via the I/O interfaces 555, and/or the I/O ports 560. Through the network devices 545, the computer 500 may interact with a network. Through the network, the computer 500 may be logically connected to remote computers. Networks with which the computer 500 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on) cause the machine (and/or associated components) to perform the method.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer storage medium”, as used herein, is a non-transitory medium that stores instructions and/or data. A computer storage medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer storage medium may include, but are not limited to, a computer-readable medium, a floppy disk, a flexible disk, a hard disk, a magnetic tape, other magnetic medium, an ASIC, a CD, other optical medium, a RAM, a ROM, a memory chip or card, a memory stick, and other media that can store instructions and/or data. Computer storage medium described herein are limited to statutory subject matter under 35 U.S.C §101.

“Logic”, as used herein, includes a computer or electrical hardware component(s), firmware, a non-transitory computer storage medium that stores instructions, and/or combinations of these components configured to perform a function(s) or an action(s), and/or to cause a function or action from another logic, method, and/or system. Logic may include a microprocessor controlled by an algorithm to perform one or more of the disclosed functions/methods, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic component. Similarly, where a single logic component is described, it may be possible to distribute that single logic component between multiple physical logic components. In some embodiments, one or more of the components and functions described herein are implemented using one or more of the logic components. Logic as described herein is limited to statutory subject matter under 35 U.S.C §101.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks. The methods described herein is limited to statutory subject matter under 35 U.S.C §101.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. §101.

Various operations of embodiments are provided herein. The order in which one or more or all of the operations are described should not be construed as to imply that these operations are necessarily order dependent. Alternative ordering will be appreciated based on this description. Further, not all operations may necessarily be present in each embodiment provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel.

Although the disclosure has been shown and described with respect to one or more implementations, equivalent alterations and modifications will occur based on a reading and understanding of this specification and the annexed drawings. The disclosure includes all such modifications and alterations and is limited only by the scope of the following claims.

What is claimed is:

1. A method, comprising:
converting qualitative data into quantitative data, wherein the qualitative data is associated with sleeves in a set of sleeves;
aggregating investment risks associated with the sleeves and risk capitals for the sleeves based on regulatory requirements;
assessing the sleeves based on investment factors including the quantitative data, the investment risks, and the risk capitals,
creating portfolios based, at least in part, on the investment factors, wherein a portfolio contains at least one sleeve from the set of sleeves;
assigning the portfolios risk weights based, at least in part, on the one or more investment factors;
comparing the risk weights of the portfolios to a risk target; and
selecting a portfolio from the set of portfolios based, at least in part, on the comparison.

2. The method of claim 1, wherein converting the qualitative data utilizes a z-score methodology.

3. The method of claim 1, wherein aggregating an investment risk comprises calculating the investment risk, and wherein the investment risk is calculated using a vended multi-asset, multi-factor, global risk model.

4. The method of claim 1, further comprising weighting a sleeve base, at least in part, on an expected return, wherein the predetermined risk of the portfolios is based at least in part on a weight of a sleeve represented in the portfolios.

5. The method of claim 1, wherein the comparison determines the maximum marginal utility for an incremental risk.

6. The method of claim 1, wherein assessing the risk of each of sleeves utilizes the quantitative data as an alpha estimate.

7. The method of claim 1, wherein portfolios are associated with Bank Owned Life Insurance (BOLI).

8. A method, comprising:
converting qualitative data into quantitative data, wherein the qualitative data is associated with sleeves in a set of sleeves;
calculating investment risks associated with the sleeves;
calculating risk capitals for the sleeves based on regulatory requirements;
creating portfolios based on investment factors including the quantitative data, the investment risks, and the risk capitals, wherein a portfolio contains at least one sleeve;
assigning the portfolios risk weights based, at least in part, on the one or more investment factors;
comparing the risk weights of the portfolios to a risk target; and
selecting a portfolio from the set of portfolios based, at least in part, on the comparison.

9. The method of claim 8, wherein converting the qualitative data utilizes a z-score methodology.

10. The method of claim 8, wherein investment risk is calculated using a vended multi-asset, multi-factor, global risk model.

11. The method of claim 8, wherein the comparison determines the maximum marginal utility for an incremental risk.

12. The method of claim 8, further comprising:
monitoring the created portfolio;
identifying anomalous characteristics of the portfolio;
determining at least one sleeve associated with the anomalous characteristics, wherein the at least one sleeve associated with the anomalous characteristics is an anomalous sleeve;
identifying a replacement sleeve; and
replacing the anomalous sleeve with the replacement sleeve.

13. The method of claim 8, further comprising identifying an anomalous sleeve and rebalancing the selected portfolio.

14. The method of claim 8, wherein portfolios are associated with Bank Owned Life Insurance (BOLI).

15. A system comprising:
an input logic configured to convert qualitative data into quantitative data, wherein the qualitative data is associated with sleeves in a set of sleeves;
a risk assessment logic configured to
receive investment risks associated with the sleeves;
determine risk capitals for the sleeves based on regulatory requirements; and
assess the sleeves based on investment factors including the quantitative data, the investment risks, and the risk capitals,
a portfolio logic configured to:
create portfolios based, at least in part, on the investment factors, wherein a portfolio contains at least one sleeve;
assign the portfolios risk weights based, at least in part, on the one or more investment factors;
compare the risk weights of the portfolios to a risk target; and
select a portfolio from the set of portfolios based, at least in part, on the comparison.

16. The system of claim 15, further comprising a normalization logic configured to normalize the quantitative data.

17. The system of claim 15, further comprising a rebalancing logic configured to: monitor the created portfolio;
identify anomalous characteristics of the portfolio;
determine at least one sleeve associated with the anomalous characteristics, wherein the at least one sleeve associated with the anomalous characteristics is an anomalous sleeve;
identify a replacement sleeve; and
replace the anomalous sleeve with the replacement sleeve.

18. The system of claim 15, further comprising a rebalancing logic configured to:
identify an anomalous sleeve; and
rebalance the selected portfolio.

19. The system of claim 15, wherein the portfolio logic 130 is further configured to determine the maximum marginal utility for an incremental risk.

20. The system of claim 15, wherein the portfolios are associated with Bank Owned Life Insurance (BOLI).
